(19) United States
(12) Patent Application Publication
(10) Pub. No.: US 2009/0109966 A1
(43) Pub. Date: Apr. 30, 2009

(54) METHOD AND APPARATUS FOR PERFORMING SYNCHRONOUS TIME DIVISION SWITCH, AND ETHERNET SWITCH

(76) Inventors: Yang Yu, Beijing (CN); Wei Wang, Beijing (CN); Jinglin Li, Beijing (CN); Chushun Wei, Beijing (CN)

Correspondence Address: LADAS & PARRY LLP, 224 SOUTH MICHIGAN AVENUE, SUITE 1600, CHICAGO, IL, 60604, US

(21) Appl. No.: 12/346,121

(22) Filed: Dec. 30, 2008

Related U.S. Application Data
(63) Continuation of application No. PCT/CN2007/070686, filed on Sep. 13, 2007.

(30) Foreign Application Priority Data
Dec. 28, 2006 (CN) 200610156712.8

(51) Int. Cl. H04L 12/52

(52) U.S. Cl. 370/376

(57) ABSTRACT

A method for performing a synchronous time division switch is provided, and the method includes: dividing, by using a time period for transmitting one byte as a unit, a time period for receiving and sending an Ethernet frame with a constant length by an Ethernet port into input time slots and output time slots, and orderly numbering the input time slots and orderly numbering the output time slots; circularly receiving data via the Ethernet port according to serial numbers of the input time slots; switching the data received at each input time slot to the output time slots corresponding to the input time slot; and circularly outputting the data at the output time slots via the Ethernet port according to serial numbers of the output time slots. An apparatus for performing a synchronous time division switch and an Ethernet switch are also provided. The method for performing a synchronous time division switch can be applied to the Ethernet and can reduce the costs of the synchronous time division switch.

### FIELD OF THE INVENTION

The present invention relates to data switch technologies, more particularly to methods and an apparatus for performing a synchronous time division switch via an Ethernet, and an Ethernet switch.

### BACKGROUND OF THE INVENTION

Packet switches provided by Ethernet switches are generally adopted for transmitting service flows which have variable rates and allow a relative large time delay jitter of end to end transmission. At present, the Ethernet switches are not only generally applied in Local Area Networks (LANs) [0], but also more and more frequently applied in Metropolitan Area Networks (MANs), because of advantages of the Ethernet switches, e.g., a low cost and a high bandwidth utilization of lines.

FIG. 1 is a schematic diagram illustrating a structure of a conventional Ethernet switch. As shown in FIG. 1, an Ethernet switch 100 includes a switch unit 110 and at least two Ethernet ports 120.

Each Ethernet port 120, which is also called as an Ethernet interface, is a bi-directional port. When input is performed, the Ethernet port 120 is adapted to receive Ethernet frames from an external device and output the received Ethernet frames to the switch unit 110. The switch unit 110 is adapted to switch the received Ethernet frames to an output queue maintained by a corresponding Ethernet port 120 according to a forwarding table stored in the switch unit 110. The output queue maintained by the corresponding Ethernet port 120 is adapted to buffer Ethernet frames to be sent by the corresponding Ethernet port 120. When output is performed, the Ethernet port 120 sends the Ethernet frames in the output queue maintained by it one by one.

Based on the above mentioned principle, it can be seen that the conventional Ethernet switch 100 outputs the Ethernet frames in the output queue maintained by it one by one according to a First Input First Output (FIFO) rule. A switch time delay of the Ethernet frame between the input and the output of the Ethernet frame relates to the length of the Ethernet frame and the output queue in which the Ethernet frame is located. When the length of the Ethernet frame is longer, the switch time delay of the Ethernet frame is longer; when the number of Ethernet frames prior to the Ethernet frame located in the same output queue is larger, or when the length of Ethernet frames prior to the Ethernet frame located in the same output queue is longer, the switch time delay of the Ethernet frame is also longer. Therefore, it can not be ensured that the Ethernet frame is transmitted at determinate intervals, since the switch time delay is not constant. In addition, the Ethernet frames buffered in the same output queue may not belong to the same service flow. For example, the first, third, fourth and seventh Ethernet frames buffered in a certain output queue belong to a service flow, and other Ethernet frames buffered in the same output queue belong to other service flows. As a result, the Ethernet frames belonging to the same service flow can not be sent out at determinate intervals, which lead to a time delay jitter of Ethernet end to end transmission, and subsequently service Quality and Service (QoS) can not be satisfied. However, time division services establish a strict requirement for time delay jitter of the end to end transmission, and a time division switch solution which can ensure the transmission with a constant rate is needed. As can be seen, the conventional Ethernet can not achieve a desirable transmission for the time division services.

While, when the synchronous time division switch is performed by using TDM interfaces, the time delay of data from an input time slot to a corresponding output time slot is constant. For a service flow, the data of the service flow is able to be periodically and rhythmically sent out at a same time slot, and thus when a time division service with a constant rate is transmitted by using the synchronous time division switch, the requirements for transmission time delay of transmitting the time division service with the constant rate are satisfied. Therefore, the synchronous time division switch can guarantee that the time delay and jitter of the time division service satisfy the Quality of Service (QoS) requirements. However, the disadvantage of using the TDM interfaces to perform the synchronous time division switch is that, the costs of the TDM interfaces and the TDM lines are high, thereby leading to a high cost of the synchronous time division switch that adopts the TDM interfaces and the TDM lines.

### SUMMARY OF THE INVENTION

A method for performing a synchronous time division switch is provided. By applying the method, a synchronous time division switch is performed via the Ethernet, and thus the costs of the synchronous time division switch is reduced.

This method includes:

dividing, by using a time period for transmitting one byte of data as a unit, a time period for receiving an Ethernet frame with a constant length by an Ethernet port into input time slots; and orderly numbering the input time slots;

dividing, by using the time period for transmitting one byte of data as a unit, a time period for sending the Ethernet frame with the constant length by the Ethernet port into output time slots; and orderly numbering the output time slots;

circularly receiving data via the Ethernet port according to serial numbers of the input time slots;

switching the data received at each input time slot to the output time slot corresponding to the input time slot; and

circularly outputting the data at the output time slots via the Ethernet port according to serial numbers of the output time slots.

Another method for performing a synchronous time division switch is also provided, which can be applied on the Ethernet to perform a synchronous time division switch, thereby reducing the costs of the synchronous time division switch.

This method includes:

dividing, by using a time period for transmitting one byte of data as a unit, a time period for receiving an Ethernet frame with a constant length by an Ethernet port into input time slots and output time slots; and orderly numbering the input time slots;

dividing, by using the time period for transmitting one byte of data as a unit, a time period for sending the Ethernet frame with the constant length by the Ethernet port into output time slots;

using the time period for transmitting the Ethernet frame with the constant length as a frame synchronous periodicity;

circularly receiving data via the Ethernet port according to serial numbers of the input time slots of the Ethernet port, and circularly receiving data via at least one of an E1 interface and a TDM interface having an integral multiple E1 rate according to serial numbers of the input time slots of the at least one of the E1 interface and the TDM interface having the integral multiple E1 rate;

switching the data received at each input time slot to the output time slot corresponding to the input time slot; and

circularly outputting the data at the output time slots via the Ethernet port according to serial numbers of the output time slots of the Ethernet port, and circularly outputting the data at the output time slots via the at least one of the E1 interface and the TDM interface having the integral multiple E1 rate according to serial numbers of the output time slots of the at least one of the E1 interface and the TDM interface having the integral multiple E1 rate.

An apparatus for performing a synchronous time division switch is also provided, which can be applied on the Ethernet to perform a synchronous time division switch, thereby reducing the costs of the synchronous time division switch.

The apparatus for performing a synchronous time division switch includes a configuration unit, a switch unit and at least two Ethernet ports; and

the configuration unit is adapted to divide, by using a time period for transmitting one byte of data as a unit, a time period for receiving an Ethernet frame with a constant length by an Ethernet port into input time slots; and orderly numbering the input time slots; divide, by using the time period for transmitting one byte of data as a unit, a time period for sending the Ethernet frame with the constant length by the Ethernet port into output time slots; and orderly number the output time slots; determine a relationship between the input time slots and the output time slots, and send the relationship to the switch unit;

the switch unit is adapted to switch data received at each input time slot to the output time slot corresponding to the input time slot according to the relationship; and

the Ethernet port is adapted to circularly receive the data according to serial numbers of the input time slots, and output the data at the output time slots via the Ethernet port according to serial numbers of the output time slots.

An Ethernet switch is also provided, which can be applied on the Ethernet to perform a synchronous time division switch, thereby reducing the costs of the synchronous time division switch.

The Ethernet switch includes:

at least one Ethernet interface unit, adapted to transmit an Ethernet frame with a constant length, and transmit the Ethernet frame with the constant length at multiple time slots, one byte being transmitted at one time slot;

at least one TDM interface unit, adapted to comprise multiple time slots, wherein a time period for transmitting the Ethernet frame with the constant length is a integral multiple of a frame synchronous periodicity of the TDM interface unit; and

a switch unit, adapted to perform a switch at the time slots between the at least one Ethernet interface unit and the at least one TDM interface unit.

By applying the solution of the synchronous time division switch provided by the embodiments of the present invention, the synchronous time division switch is performed via the Ethernet, and thus the costs of the synchronous time division switch is reduced.

Specifically, in the embodiments of the present invention, data are received, switched and sent through an Ethernet port by using one time slot as a unit. since the length of the time slot remains unchanged, the time slots do not interfere with each other, and the time slots are circularly used by turn to receive and send the data, so that the switch time delay is unchanged for the data at each time slot, and thus the synchronous time division switch can be performed for the data of the time division service with the constant rate via the Ethernet, thereby satisfying the requirements of transmission time delay for transmitting the time division service with the constant rate. In addition, by applying the embodiments of the present invention, the synchronous time division switch can be performed between Ethernet ports and at least one of E1 interfaces and TDM interfaces having integral multiple E1 rates, and the requirements of transmission time delay for transmitting the time division service with the constant rate are also satisfied. Compared with the synchronous time division switch implemented on the TDM lines, by applying the embodiments, the costs of the synchronous time division switch are reduced since the cost of the Ethernet is low.

### BRIEF DESCRIPTION OF THE DRAWINGS

FIG. 1 is a schematic diagram illustrating a structure of a conventional Ethernet switch.

FIG. 2 is a schematic diagram illustrating a receiving or sending time sequence of an E1 interface.

FIG. 3 is a schematic diagram illustrating a synchronous time division switch with a plurality of 2.048 MHz TDM interfaces.

FIG. 4 is a flow diagram illustrating a method for performing a synchronous time division switch in accordance with an embodiment of the present invention.

FIG. 5 is a flow diagram illustrating a method for performing a synchronous time division switch in accordance with another embodiment of the present invention.

FIG. 6 is a schematic diagram illustrating a conventional frame structure of an Ethernet frame defined in IEEE802.3.

FIG. 7 is a schematic diagram illustrating a frame structure of an Ethernet frame with a constant length in accordance with an embodiment of the present invention.

FIG. 8 is a schematic diagram illustrating a principle of a synchronous time division switch in accordance with an embodiment of the present invention.

FIG. 9 is a schematic diagram illustrating an interface between a MAC layer and a PHY layer.

FIG. 10 is a schematic diagram illustrating signal interactions between MII interfaces defined in IEEE802.3.

FIG. 11 is a schematic diagram illustrating a time sequence when an MAC layer receives an Ethernet frame with a constant length from a PHY layer in an Ethernet port in accordance with an embodiment of the present invention.

FIG. 12 is a schematic diagram illustrating a time sequence when an MAC layer sends an Ethernet frame with a constant length to a PHY layer in an Ethernet port in accordance with an embodiment of the present invention.

FIG. 13 is a schematic diagram illustrating a structure of an apparatus for performing a synchronous time division switch in accordance with an embodiment of the present invention.

FIG. 14 is a schematic diagram illustrating a structure of a switch unit 1320 in FIG. 13.

### DETAILED DESCRIPTION OF THE INVENTION

Detailed descriptions of the present invention are hereinafter given with reference to the attached drawings and detailed embodiments.

Time Division Multiplex (TDM) switch technologies are frequently adopted to implement transmission of the time division services at present. In the TDM switch technologies, a time period on one communication line is divided into time blocks which are also called as frames according to a certain periodicity, and each frame is divided into several time slots. Each time slot carries a service flow, and different service flows are identified according to different locations of the time slots. When a TDM switch is performed under the control of a synchronous clock, the TDM switch is called as a synchronous time division switch.

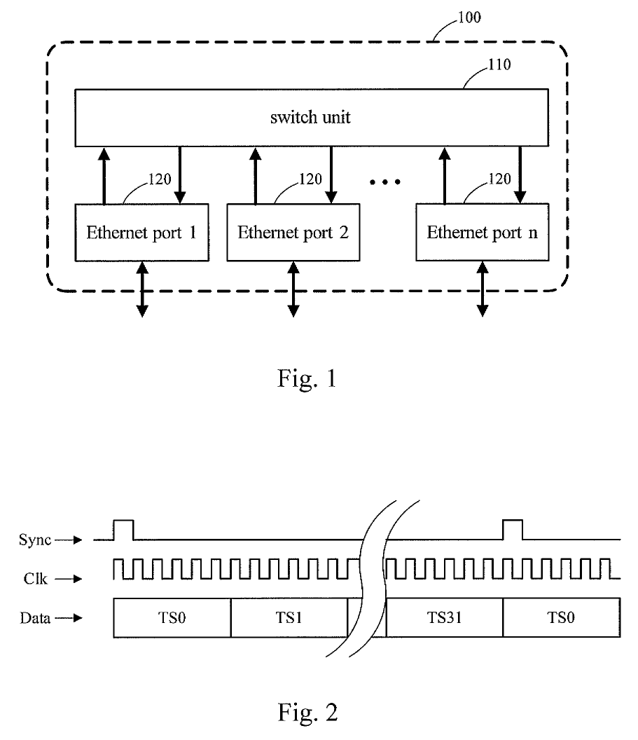

The synchronous time division switch is typically used in a plurality of TDM interfaces of a digital procedure control switch. The TDM interface is a bi-directional time division multiplex interface, each of a sending side and a receiving side of the TDM interface has a synchronous clock signal, a frame synchronous signal and a data signal. The above described three signals are necessary signals when the TDM interface is adopted to perform a synchronous time division switch. The generally used TDM interfaces include E1 interfaces in a framing mode and TDM interfaces having an integral multiple E1 rate. FIG. 2 is a schematic diagram illustrating a receiving or sending time sequence of an E1 interface. As shown in FIG. 2, each of the receiving side and the sending side of the E1 interface has a 2.048 MHz clock signal (Clk), a 8 KHz frame synchronous signal (Sync) and a data signal (Data). The clock signal Clk provides a reference clock for data transmission and one byte of data is transmitted every 8 clock periodicities. The frame synchronous signal Sync provides a frame synchronous periodicity and one frame is carried in one frame synchronous periodicity. The time period for transmitting each frame is divided into 32 time slots by using the time period for transmitting one byte of data as a unit, and the time slots are orderly numbered, each of the time slots carries a service flow. When the frame synchronous signal is available, the data of the frames is started to be received or sent according to the serial number of the time slots. The Time Slot in FIG. 2 is indicated by TS. In order to distinguish the time slots for frames receiving from the time slots for frames sending, the time slots for frames receiving are called as input time slots, and the time slots for frames sending are called as output time slots.

In practical applications, the TDM interfaces corresponding to a synchronous time division switch have the frame synchronous signals with the same periodicity, which usually is 8 KHz. The local clock frequencies of the TDM interfaces are equal to each other or have integral multiple relationships, such as 2.048 MHz, 4.096 MHz, 8.192 MHz, 16.384 MHz, 32.768 MHz, etc. In this way, when the periodicities of the frame synchronous signals are identical, the TDM interfaces with the same rate have the same number of time slots, and the TDM interfaces with integral multiple rate have time slots the number of which also have integral multiple relationships. For example, a TDM interface with the frequency of 2.048 MHz has 32 time slots, while a TDM interface with the frequency of 4.096 MHz has 64 time slots.

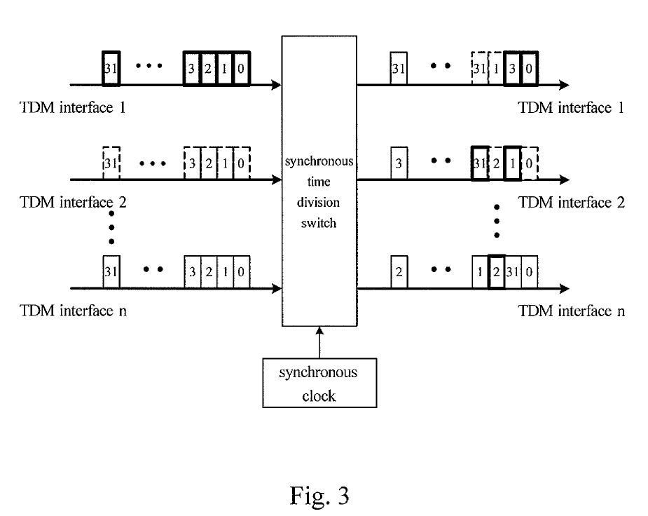

FIG. 3 is a schematic diagram illustrating a synchronous time division switch with a plurality of 2.048 MHz TDM interfaces. As shown in FIG. 3, the number of TDM interfaces joining into the synchronous time division switch is n, and n≧1; each TDM interface has 32 time slots, i.e. time slot 0 to time slot 31. Blocks with digitals indicate time slots, and the digitals in the blocks are the serial numbers of the time slots. The different line types of the blocks indicate that the time slots correspond to different TDM interfaces. The left-hand half of the figure illustrates input time slots, and the right-hand half of the figure illustrates output time slots. When a synchronous time division switch is performed, under a control of a synchronous clock and according to a predetermined relationship between the input time slots and the output time slots, the data that are received at an input time slot by the TDM interface by using one byte as a unit are sent through an output time slot of a TDM interface corresponding to the input time slot. Taken the data received by TDM interface 1 at input time slot 2 as an example, the data are sent out by TDM interface n at output time slot 2 according to a predetermined relationship. Usually, the time slot 0 is used to transmit synchronous information and is the first time slot of a frame.

The embodiments of the present invention provide a solution for performing a synchronous time division switch. In the embodiments, Ethernet ports output Ethernet frames with a constant length at constant time intervals, and receive Ethernet frames with a constant length from upstream and downstream devices at the same time intervals. The time period for transmitting the Ethernet frames with the constant length is divided into multiple time slots by using a time period for transmitting one byte of data as a unit, and the time slots are numbered. Under the control of a synchronous clock, each Ethernet ports adopts the time period for transmitting the Ethernet frames with the constant length as a frame synchronous periodicity, receives and sends data according to the serial numbers of the time slots, and implements the synchronous time division switch between the Ethernet ports by using the time slot as a unit. Since the synchronous time division is implemented via the Ethernet, the cost of the synchronous time division switch is efficiently reduced.

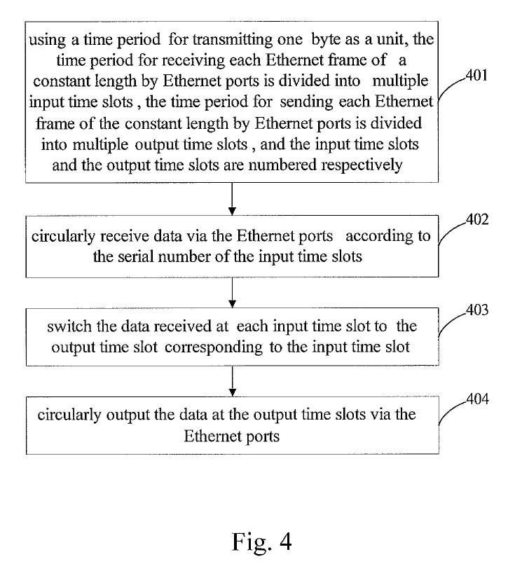

FIG. 4 is a flow diagram illustrating a method for performing a synchronous time division switch in accordance with an embodiment of the present invention. As shown in FIG. 4, the method includes the following processes.

At step 401, a time period for receiving an Ethernet frame with a constant length by each Ethernet port is divided into multiple input time slots by using a time period for transmitting one byte of data as a unit, a time period for sending an Ethernet frame with a constant length by each Ethernet port is divided into multiple output time slots by using the time period for transmitting one byte of data as a unit, and the input time slots and the output time slots are orderly numbered respectively.

At step 402, data are received through the Ethernet ports circularly according to the serial numbers of the input time slots.

At step 403, the data received at each input time slot are switched to the output time slot corresponding to the input time slot.

At step 404, the data at each output time slot are circularly output via the Ethernet ports.

As can be seen from the flowchart of FIG. 4, by constructing the Ethernet frames with the constant length and dividing the time period for transmitting the Ethernet frames with the constant length into input time slots or output time slots, the method for performing the synchronous time division switch of the present invention can implement that data is received and sent by using one time slot as a unit and the synchronous time division switch is performed by using one time slot as a unit. Due to the low cost of the Ethernet, the quality-price ratio of the synchronous time division switch performed according to the embodiments of the present invention is better than that of the conventional synchronous time division switch implemented on the TDM lines.

The method for performing a synchronous time division switch of the present invention will be described in detail with reference to specific embodiments.

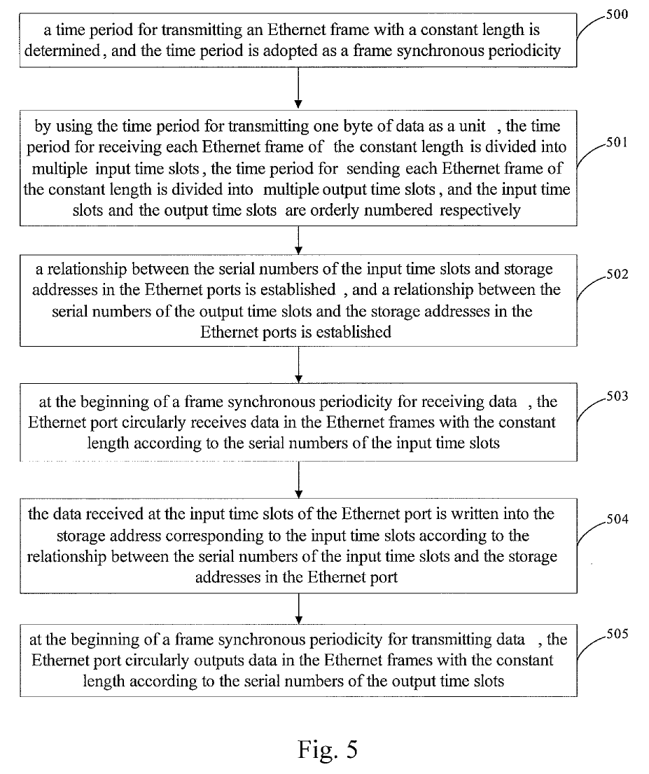

FIG. 5 is a flow diagram illustrating a method for performing a synchronous time division switch in accordance with an embodiment of the present invention. As shown in FIG. 5, the method includes the following processes.

At step 500, a time period for transmitting an Ethernet frame with a constant length is determined, and the time period is adopted as a frame synchronous periodicity. The time period is the time period for receiving the Ethernet frames with the constant length, and also is the time period for sending the Ethernet frames with the constant length.

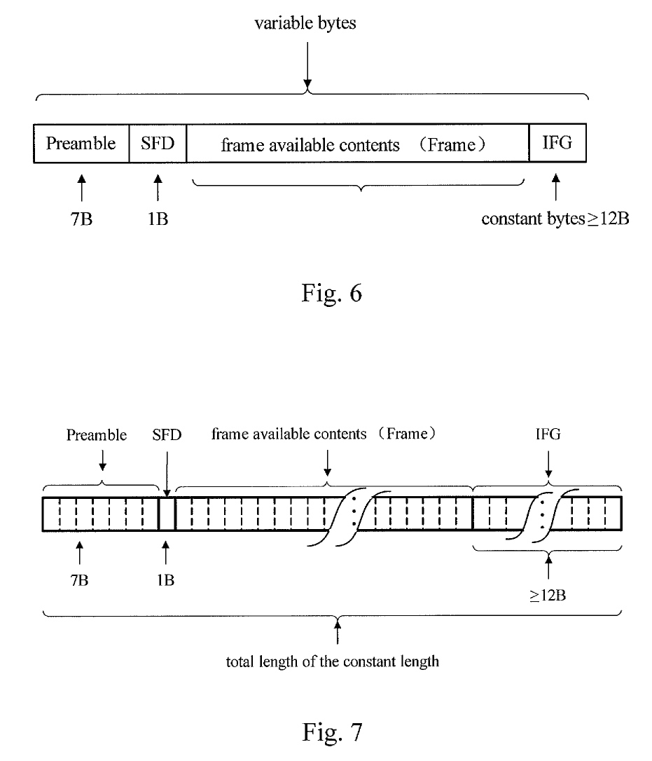

FIG. 6 is a schematic diagram illustrating a conventional frame structure of an Ethernet frame defined in IEEE802.3. As shown in FIG. 6, an Ethernet frame includes: a Preamble of 7 bytes, a Start Frame Delimiter (SFD) of 1 byte, frame available contents of variable bytes, and an Inter Frame Gap (IFG) of constant bytes. IEEE802.3 provisions that the IFG of 10 Mbps, 100 Mbps, and 1000 Mbps data occupies at least 12 bytes; the frame available contents include a frame head, frame data and a frame check code, etc, and the frame available contents carry the data of the same service flow.

FIG. 7 is a schematic diagram illustrating a frame structure of an Ethernet frame with a constant length in accordance with an embodiment of the present invention. In this figure, each small block indicates one byte. As shown in FIG. 7, the sameness between the Ethernet frame with a constant length in the embodiment and that in FIG. 6 includes the Preamble of 7 bytes, the SFD of 1 byte, and the IFG of 12 bytes or more that 12 bytes. The differences include that the total length of the Ethernet frame with the constant length is constant for a same Ethernet port, and the time period for transmitting the total length is used as the frame synchronous periodicity of the synchronous time division switch. The frame available contents in the Ethernet frame with the constant length are divided into a plurality of data units by using one byte as a unit, each data unit carry the data of one service flow. In this way, the frame available contents of one Ethernet frame with the constant length is able to carry data of more than one service flow.

At this step, the time period for transmitting the Ethernet frame with the constant length may be determined as acquired, and then the largest number of the service flows that can be carried in one Ethernet frame with the constant length is calculated according to the rate of the Ethernet port.

Specifically, there are flowing steps: 1) the time period for transmitting the Ethernet frame with the constant length is determined; 2) according to the rate of the Ethernet port, the number of bytes that can be transmitted within the time period is calculated, i.e. the number of the bytes in the Ethernet frame with the constant length is calculated, here, the number of the bytes in the Ethernet frame with the constant length=the time period for transmitting the Ethernet frame with the constant length/the time period for transmitting one byte; 3) according to the number of the bytes in the Ethernet frame with the constant length, the largest number of the service flows that can be carried in one Ethernet frame with the constant length is determined, and an integral number that is less than or equal to the largest number is selected as the number of the service flows that are actually carried in one Ethernet frame, here, the largest number of the service flows that can be carried in one Ethernet frame=the number of the bytes in the Ethernet frame with the constant length—7 bytes for the Preamble—1 byte for the SFD—at least 12 bytes for the IFG; 4) the length of the actual IFG is determined, here, the length of the actual IFG=the number of the bytes in the Ethernet frame with the constant length—the number of the service flows that are actually carried in one Ethernet frame—7 bytes for the Preamble—1 byte for the SFD.

The process for determining the number of bytes in each part of the Ethernet frame with the constant length is described with reference to the following example. In order to be in conformity with the frame synchronous periodicity of an E1 interface, the time period for transmitting the Ethernet frame with the constant length is determined as 125 μs. For a 10 Mbps Ethernet port, the number of bytes in the Ethernet frame with the constant length is 125 μs/(0.1 μs×8) 156.25. Here, (0.1 μs×8) indicates the clock periodicity when a byte of 8 bits occupies 8 Ethernet ports. And then, apart from the Preamble of 7 bytes, the SFD of 1 byte, and the IFG of at least 12 bytes, the remaining 156.25−7−1−12=136.25 bytes in the Ethernet frame with the constant length can carry at most 136.25 service flow, and 128 service flows which is equivalent to 4 E1 flow are selected to be carried in order to be in conformity with the E1 interface. As such, the length of the IFG in the Ethernet frame with the constant length=156.25−128−7−1=20.25 bytes. Since an MII interface in an Ethernet port transmits 0.5 bytes every clock, when the Ethernet port with the MII interface is used, the Ethernet port is configured to transmit an Ethernet frame with a constant length which contains 20.25 bytes of IFG and an Ethernet frame with a constant length which contains 20 bytes of IFG by turn.

It is noted that, for Ethernet ports using the same frame synchronous periodicity, if the rates of the Ethernet ports are different, the numbers of the bytes in the Ethernet frames with the constant length is different. For example, when the frame synchronous periodicity is a constant of 125 μs, for 10 Mbps Ethernet ports, the number of the bytes in the Ethernet frame with the constant length is 156.25, but for 100 Mbps Ethernet ports, the number of the bytes in the Ethernet frame with the constant length is 1562.5. If the Ethernet frame with the constant length is determined to carry 1280 service flows, the length of the IFG=1562.5−1280−7−1=274.5 bytes.

At step 501, the time period for receiving the Ethernet frame with the constant length by the Ethernet port is divided into multiple input time slots by using the time period for transmitting one byte of data as a unit, the time period for sending the Ethernet frame with the constant length by the Ethernet port is divided into multiple output time slots by using the time period for transmitting one byte of data as a unit, and the input time slots are orderly numbered, and the output time slots are orderly numbered.

At this step, the time period for transmitting the Ethernet frame with the constant length determined by step 500 is used as the frame synchronous periodicity of the synchronous time division switch. For example, for a certain Ethernet port, when the frame synchronous periodicity is 100 μs, 100 μs/(0.1 μs×8)=125 bytes can be transmitted in this frame synchronous periodicity. After the time period is divided into time slots by using one byte as a unit, this Ethernet port has 125 time slots. And then the 125 time slots are circularly numbered, thereby obtaining time slots from time slot 0 to time slot 124. As described in the example of step 500, for the 10 Mbps Ethernet ports, the bytes of the Ethernet frame with the constant length is 156.25 bytes, and for 100 Mbps Ethernet ports, the bytes of the Ethernet frame with the constant length is 1562.5 bytes. That is, there are non-integral time slots. Usually, the non-integral time slots are located at the location of the IFG in the Ethernet frame with the constant length and do not carry service flow, and thus do not affect the dividing of the time slots and the transmission of the service flow.

At step 502, a relationship between the serial numbers of the input time slots and storage addresses is established for each Ethernet port, and a relationship between the serial numbers of the output time slots and the storage addresses is established for each Ethernet port. The storage addresses are addresses in a data storage used for buffering received data, and a switch is implemented by storing the data in the data storage and then retrieving from the data storage.

At step 503, at the beginning of a frame synchronous periodicity for receiving data, the Ethernet port circularly receives data in the Ethernet frames with the constant length according to the serial numbers of the input time slots.

At this step, when the data are received in turn at the input time slots according to the serial numbers of the input time slots, three signals, i.e. a clock signal Clk, a frame synchronous periodicity signal Sync and a data signal Data are necessary, as that in TDM interfaces. Specifically, in an input procedure, a receiving clock signal RX_Clk, a receiving frame synchronous signal RX_Sync and a receiving data signal RX_Data are necessary, while in an output procedure, a sending clock signal TX_Clk, a sending frame synchronous signal TX_Sync and a sending data signal TX_Data are necessary. The processes for generating the three necessary signals for the synchronous time division switch is described after this flow is described.

At step 504, the data received at the input time slots of the Ethernet port is written into the storage address corresponding to the serial number of input time slots according to the relationship between the serial numbers of the input time slots and the storage addresses of the Ethernet port.

The receiving and storing operations at the above steps 503 and 504 are implemented circularly.

At step 505, at the beginning of a frame synchronous periodicity for sending data, the Ethernet port circularly outputs data in the Ethernet frames with the constant length according to the serial numbers of the output time slots.

When the data at a certain output time slot is output, according to the relationship between the serial numbers of the output time slots and the storage addresses of the Ethernet port, the storage address corresponding to the certain output time slot is determined, and the data is retrieved from the determined storage address and is output through the Ethernet port.

In practical applications, the relationship between the serial numbers of the input time slots and the storage addresses of each Ethernet port is usually configured to be unchanged, and the relationship between the serial numbers of the output time slots and the storage addresses of each Ethernet port may be manually or dynamically configured. The relationship between the serial numbers of the input time slots and the storage addresses of each Ethernet port may also be manually or dynamically configured. The detailed configuration procedures are known technique and are not the problem to be solved by the embodiments of the present invention, and thus are not described any more.

The operations at above steps 503-505 need to be implemented according to local synchronous clock of each Ethernet port. Also, in order to ensure that the time slots for receiving and sending data is accurately aligned, and in order to maintain a accurate data switch at local in the Ethernet ports, it requires that the local synchronous clocks of each Ethernet ports is synchronous and the local synchronous clocks is synchronous with clocks of the upstream and downstream devices. In the embodiments of the present invention, the local synchronous clocks are calibrated by obtaining synchronous information.

There are plenty of existing solutions for providing the synchronous information in an Ethernet system. For example, one of the solutions includes obtaining the synchronous information by extracting the clock of upstream lines, and providing sending clock used as the synchronous information to the downstream device of the Ethernet switch. one of the solutions includes obtaining the synchronous information by calculating the sending time and arriving time of an Ethernet frame with a constant length according to methods provided in IEEE 1588 and IEEE 802.1 as, etc. one of the solutions includes obtaining the synchronous information by using a synchronous system of a Global Positioning System (GPS). And one of the solutions includes obtaining the synchronous information by using a synchronous network of a conventional Plesiochronous Digital Hierarchy (PDH) or a Synchronous Digital Hierarchy (SDH).

The procedure of the synchronous time division switch is completed.

In practical applications, since the protocols define that each Ethernet frame with the constant length should carry the Preamble, the SFD, and the IFG, which are unchanged and are not service flow, such information may be not switched.

Therefore, at step 501, only the time slots carrying the service flows in the Ethernet frame with the constant length are orderly numbered, the input time slots and output time slots corresponding to the Preamble, the SFD, and the IFG in the Ethernet frame with the constant length are not numbered. For instance, for an Ethernet frame with a constant length that can carry 128 service flows, only the time slots 0-127 corresponding to the part that carries the service flows in the Ethernet frame are orderly numbered.

At step 503, the Preamble, the SFD, and the IFG are received similarly at the input time slots corresponding to the Preamble, the SFD, and the IFG.

In the output procedures of the switch at steps 504 and 505, the input time slots corresponding to the Preamble, the SFD, and the IFG are not switched. After the Ethernet frame with the constant length is received, the Preamble, the SFD, and the IFG in the Ethernet frame are discarded, and before the switched Ethernet frame with the constant length is to be output, the Preamble, the SFD, and the IFG are configured into the corresponding time slots in the switched Ethernet frame.

Specifically, at step 504, before the data received at the input time slot of the Ethernet port is written into the corresponding storage address, it is determined that whether the input time slot corresponding to the received data, i.e. the data to be switched has the serial number; if the input time slot corresponding to the received data has serial number, the received data is written into the corresponding storage address; otherwise, the received data is directly discarded and the data of the next input time slot is to be processed.

At step 505, before the storage address corresponding to the output time slot is determined, it is determined that whether the output time slot corresponding to the data to be sent has serial numbers; if the output time slot corresponding to the data to be sent has serial numbers, the storage address is determined and the data is read from the storage address, so that the data to be sent is obtained; otherwise, the output time slot corresponding to the data to be sent do not have the serial number, and the Preamble, the SFD, or the IFG corresponding to the output time slot is output. It is determined according to the specific location of the output time slot corresponding to the data to be transmitted in the Ethernet frame with the constant length which one of the Preamble, the SFD, and the IFG is outputted.

In practical applications, the rate of each Ethernet port that joins in the switch may be identical, or have integral multiple relationships. When a same frame synchronous periodicity is used, the Ethernet ports with the same rate have the same number of time slots, the Ethernet ports with the rates having integral multiple relationships have time slots, the number of witch also have integral multiple relationships. As long as the frame synchronous periodicities are identical, each Ethernet port can perform a switch with an E1 interface or a TDM interface having an integral multiple E1 rate of an existing procedure control switch.

In such a case, it needs to establish a relationship between storage addresses and the serial numbers of input time slots of each E1 interface and/or each TDM interface having the integral multiple E1 rate, and to establish a relationship between storage addresses and the serial numbers of output time slots of each E1 interfaces and/or each TDM interface having the integral multiple E1 rate. When the frame synchronous periodicities of each Ethernet port, each E1 interface and each TDM interface having the integral multiple E1 rate are identical, a synchronous time division switch can be performed. Usually, the rate of the E1 interface is 2.048 MHz, the frame synchronous periodicity of the E1 interface is 125 μs and the E1 interface has 32 time slots. When the Ethernet ports and at least one of the E1 interfaces and TDM interfaces having the integral multiple E1 rate perform a data switch, the rate of the Ethernet ports needs to be configured as the E1 rate or an integral multiple E1 rate, and the frame synchronous periodicity of the Ethernet ports needs to be configured as 125 μs. In this way, the interfaces joining in the synchronous time division switch have the same frame synchronous periodicity, and the rates of the interfaces have integral multiple relationships.

Therefore, by using the method for performing a synchronous time division switch provided by the embodiments of the present invention, the data switch between the Ethernet port and at least one of the E1 interface and TDM interface, the data switch between at least one of the E1 interface and TDM interface and at least one of the E1 interface and TDM interface, and the data switch between Ethernet ports can be achieved.

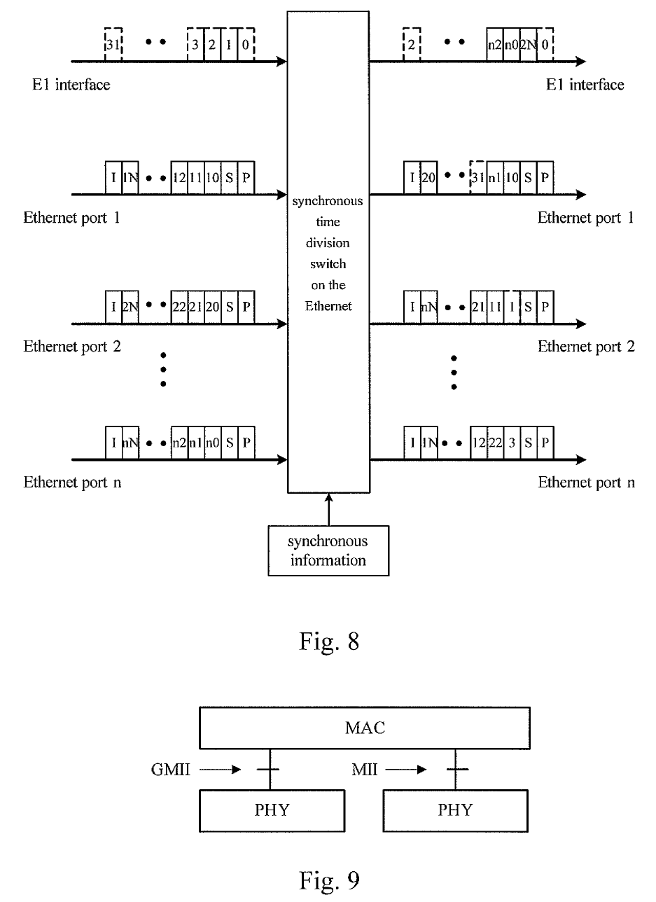

FIG. 8 is a schematic diagram illustrating a principle of a synchronous time division switch in accordance with an embodiment of the present invention. As shown in FIG. 8, n Ethernet ports and one E1 interface join in a switch, and n≧1. Two or more E1 interfaces may be join in the switch. Each of Ethernet frames with a constant length received and sent by each Ethernet port includes a Preamble of 7 bytes, a SFD of 1 byte, frame available contents of N bytes, and a IFG of constant bytes. In the time slots of the Ethernet ports shown in FIG. 8, blocks with a letter P indicate the Preamble of 7 bytes, blocks with a letter S indicate the SFD of 1 byte, and blocks with a letter I indicate the IFG of constant bytes. The blocks with digitals indicate service flow of 1 byte. The first digital in the right of the digital is the serial number of the time slot, and the second digital is used to distinguish different Ethernet ports. In the present embodiment, the time slots corresponding to the Preamble, the SFD, and the IFG are not numbered. For the time slots of the E1 interface in FIG. 8, the serial numbers of the time slots of the E1 interface are from 0 to 31, i.e. the E1 interface has 32 time slots. Before the switch is performed, the Preamble, the SFD, and the IFG are removed from the Ethernet frame with the constant length, and only the data carried by the numbered time slots are switched in the synchronous time division switch. After the switch is performed, the Preamble, the SFD, and the IFG are added to construct the Ethernet frame with the constant length, so that the Ethernet frame with the constant length can be transmitted via the Ethernet. Because time slot 0 of the E1 interface is not switched and is located in the first location, for the E1 interface in FIG. 8, only the time slots except for time slot 0 are switched in the synchronous time division switch.

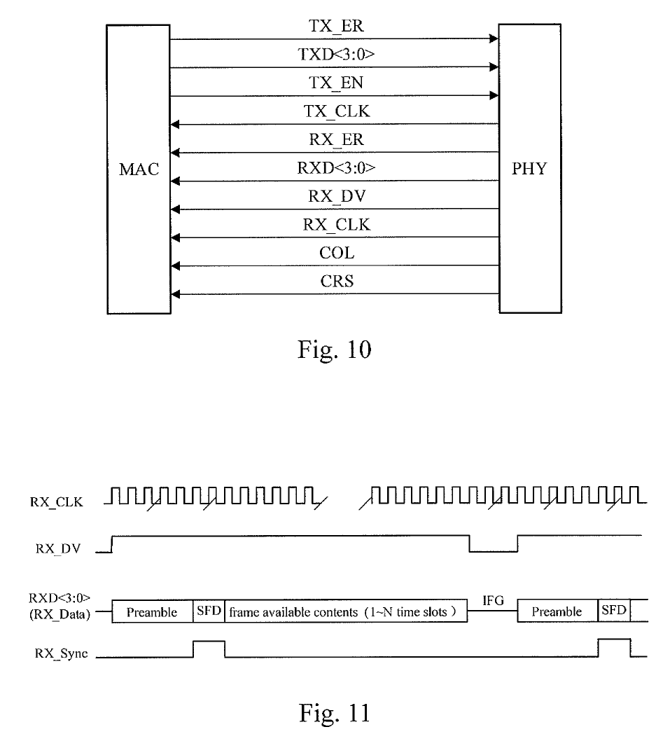

The followings describe the detailed implementation of receiving and sending data by the Ethernet ports according to the time slots by referencing to the physical structures of the Ethernet ports defined in IEEE802.3. The Ethernet port usually adopts a combination structure including a Media Access Control (MAC) layer and a Physical (PHY) layer, and functions of the MAC layer are integrated into a switch unit in an Ethernet switch, and functions of the PHY layer are a portion of the Ethernet port. FIG. 9 is a schematic diagram illustrating an interface between the MAC layer and the PHY layer. As shown in FIG. 9, the MAC layer and the PHY layer are usually connected with each other via a Media Independent Interface (MII) or a Gigabyte Media Independent Interface (GMII). In practical applications, other interfaces improved based on the MII or GMII may be used, such as a Reduced Gigabyte Media Independent Interface (RGMII), etc. Herein taken the MII interface as an example, the detailed implementation of receiving and sending data by the Ethernet ports adopting the MII interfaces according to the time slots are described. FIG. 10 is a schematic diagram illustrating signal interactions between MII interfaces defined in IEEE802.3.

TABLE 1

| | | Remarks relating |
|---|---|---|
| signals | functions | to GMII |
| TXD<3:0> | MAC output, for outputting data | TXD<7:0> |
| TX_EN | MAC output, for indicating the start and | |
| | end of an available transmitting frame | |
| TX_CLK | PHY output, for sending clock, | GTX_CLK,MAC |
| | synchronous TX_ER, synchronous TXD, | output, frequency is |
| | synchronous TX_EN signals, etc. 25 MHz | 125 MHz |
| | for a 100 M mode and 2.5 MHz for a | |
| | 10 M mode | |
| RXD<3:0> | PHY output, for receiving data | RXD<7:0> |
| RX_DV | PHY output, for indicating the start and | |
| | end of a received data | |
| RX_CLK | PHY output, for receiving clock, , | |
| | synchronous RX_ER, synchronous RXD, | |
| | and synchronous RX_DV signals, etc. | |
| | 25 MHz for a 100 M mode and 2.5 MHz | |
| | for a 10 M mode | |

With reference to FIG. 10 and the partial functions of the MII interface shown in table 1, the rhythm of receiving the data by the Ethernet port is controlled by the receiving enable signal RX_DV, and the RX_DV may be used as the receiving frame synchronous signal RX_Sync; the receiving periodicity signal RX_CLK is used as the receiving clock signal RX_Clk; and the RXD<3:0> is used as receiving data signal RX_Data. FIG. 11 is a schematic diagram illustrating a time sequence when an MAC layer receives an Ethernet frame with a constant length from a PHY layer in an Ethernet port in accordance with an embodiment of the present invention. As shown in FIG. 11, the PHY layers of different MII or GMII interfaces differently process the Preamble when the PHY layers receives the Ethernet frame with the constant length. Some PHY layers do not communicate the Preamble with the MAC interfaces, and then the receiving enable signal RX_DV and the SFD may be used together to generate the receiving frame synchronous signal RX_Sync, that is, when the receiving enable signal RX_DV is enabled and the SFD is received, the RX_Sync is enabled. Therefore, for the PHY layers of different MII or GMII interfaces, the generated RX_Sync is a periodically signal, and the length between two available edges of the RX_Sync signal is equal to the time period for transmitting the Ethernet frame with the constant length and has an unchanged phase relationship with the time slot of the frame available contents that need to be switched. Thus the generated RX_Sync may be used as the receiving frame synchronous signal RX_Sync. For the interface used to transmit the Preamble between the PHY layer and MAC layer, the receiving enable signal RX_DV may be used as the receiving frame synchronous signal RX_Sync.

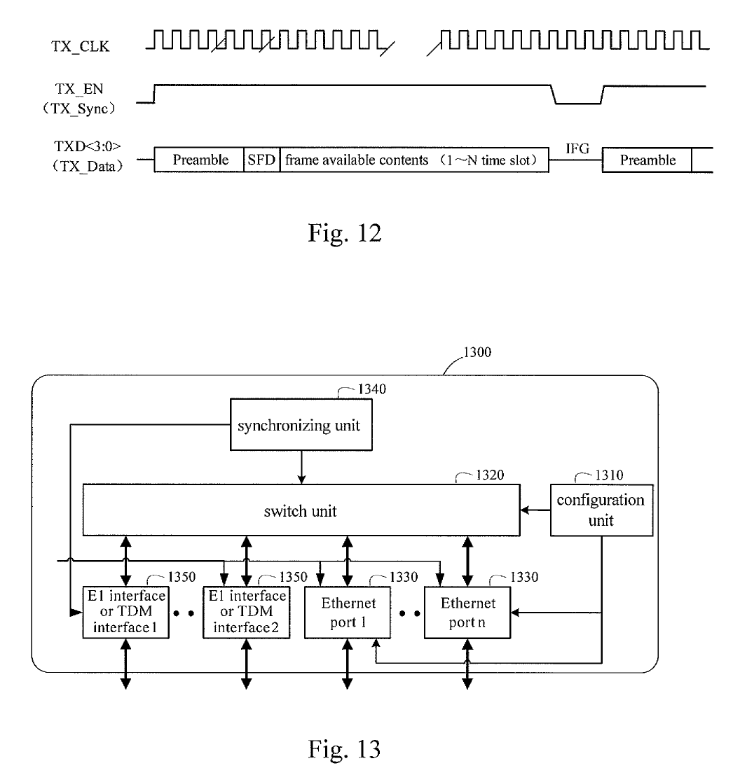

FIG. 12 is a schematic diagram illustrating a time sequence when an MAC layer sends an Ethernet frame with a constant length to a PHY layer in an Ethernet port in accordance with an embodiment of the present invention. As shown in FIG. 12, the rhythm of outputting the data by the Ethernet port is controlled by the sending enable signal TX_EN. When an available edge of the sending enable signal TX_EN is coming, the Preamble, the SFD and the frame available contents of the Ethernet frame are started to be orderly output; when the available edge of the sending enable signal TX_EN is ended, the IFG is started to be transmitted. Consequently, by enabling and disabling the sending enable signal TX_EN, the sending enable signal TX_EN may be used as the sending frame synchronous signal TX_Sync, and the sending enable signal TX_EN may be enabled at intervals of the time period for transmitting the Ethernet frames with the constant length. In table 1, the sending periodicity signal TX_CLK may be used as the sending clock signal TX_Clk, the output data are carried on the TXD<3:0> signal to be outputted, the TXD<3:0> signal is used as sending data signal TX_Data and the data of one time slot are outputted every two TX_Clks. For a GNII interface, the data of one time slot are outputted every one clock periodicity. For the case that the Preamble, the SFG and the IFG are not switched, when the sending enable signal TX_EN is enabled, the MAC layer directly provides the Preamble, the SFG and the IFG with predetermined bytes to the PHY layer at corresponding time slots, and then the PHY layer may send the Ethernet frame with the constant length including the Preamble, the SFG and the IFG.

In order to implement the method for performing a synchronous time division switch according to an embodiment of the present invention, an apparatus for performing a synchronous time division switch is also provided, and the apparatus for performing a synchronous time division switch is used in the Ethernet.

FIG. 13 is a schematic diagram illustrating a structure of an apparatus for performing a synchronous time division switch in accordance with an embodiment of the present invention. As shown in FIG. 13, the apparatus for performing a synchronous time division switch 1300 includes a configuration unit 1310, a switch unit 1320, and n Ethernet ports 1330, and n≧1.

The configuration unit 1310 is adapted to divide a time period, at which the Ethernet port 1330 receives an Ethernet frame with a constant length, into multiple input time slots, divide a time period, at which the Ethernet port 1330 sends an Ethernet frame with a constant length, into multiple output time slots, and orderly number the divided input time slots and output time slots; determine a relationship between the divided input time slots and output time slots, and send the determined relationship to the switch unit 1320.

The switch unit 1320 is adapted to switch the data to be switched that are received at the input time slots to the corresponding output time slots of the corresponding Ethernet port according to the received relationship between the divided input time slots and output time slots, thereby achieving the switch between each Ethernet port.

The Ethernet port 1330 is adapted to transmit the Ethernet frame with the constant length according to the multiple time slots. Here, one byte of data is transmitted at one time slot. In transmission, data from an external device are circularly received according to the serial numbers of the input time slots, and data at each output time slot are outputted according to the serial numbers of the output time slots.

In practical applications, the Ethernet port 1330 and the switch unit 1320 are controlled under a local synchronous clock. In order to ensure the accuracy of the local synchronous clock, as shown in FIG. 13, the apparatus for performing a synchronous time division switch 1300 further includes a synchronizing unit 1340, adapted to provide obtained synchronous information to the switch unit 1320 and the Ethernet port 1330. The synchronous information is used to align the local synchronous clock. The synchronous information may be obtained by calculating the sending time and arriving time of the Ethernet frame with the constant length according to methods provided in IEEE 1588, IEEE 802.1 as, etc, or by extracting the clock of upstream lines via a physical layer chip, or by using a synchronous system of the GPS, or by using a synchronous network of the PDH or the SDH.

The Ethernet port 1330 according to the embodiments of the present invention may receive and output data by using one time slot as a unit. As described foregoing, the Ethernet port 1330 usually adopts a combination structure of the MAC layer and the PHY layer shown in FIG. 9. The functions of the MAC layer are integrated into the switch unit 1320 and the functions of the PHY layer are a portion of the Ethernet port 1330. The MlI interfaces or GMII interfaces are adopted between the switch unit 1320 and the Ethernet ports 1330, and data are received and output between the switch unit 1320 and the Ethernet port 1330 by using one time slot as a unit. The MII interfaces or GMII interfaces are controlled by the local synchronous clock, and when the Ethernet frame with the constant length is received and output, the time period for transmitting the Ethernet frame with the constant length is used as the frame synchronous periodicity, the Ethernet frame with the constant length is received or output at the start of every frame synchronous periodicity, and the receiving and the output are performed orderly according to the serial numbers of the input time slots or the output time slots.

Specifically, when data are received, the frame synchronous periodicity is the receiving frame synchronous periodicity and is provided by the receiving frame synchronous signal RX_Sync. Since different PHY layers differently process the Preamble, the PHY layer outputs the receiving frame synchronous signal RX_Sync when the receiving enable signal RX_DV is enabled and the SFD is received, and then the MAC layer starts to receive the SFD, the frame available contents and the IFG by using one time slot as a unit when a rising edge of the RX_Sync is coming, and wait for the next rising edge of the RX_Sync. If the PHY layer transmits the Preamble to the MAC layers, the RX_DV may be directly used as the RX_Sync, and the data are started to be received when the RX_DV is enabled. Therefore, under the control of the PHY layers, the MAC layers may receive the data according to the serial numbers of the input time slots and according to the frame synchronous periodicity determined by the receiving frame synchronous signal RX_Sync.

When data are sent, the frame synchronous periodicity is the sending frame synchronous periodicity, and is provided by the sending frame synchronous signal TX_Sync. The MAC layers adopt the sending enable signal TX_EN as the sending frame synchronous signal, enable the sending enable signal TX_EN every frame synchronous periodicity, start to output the Preamble of 7 bytes and the SFD of 1 byte, and orderly output the frame available data corresponding to the multiple output time slots according to the serial numbers of the output time slots. When the transmission of the frame available contents is done, the sending enable signal TX_EN is disabled, and the IFG corresponding to a constant number of time slots is started to be transmitted. Therefore, the MAC layers may control the Ethernet ports to output data according to the serial numbers of the output time slots and according to the frame synchronous periodicity determined by the transmitting frame synchronous signal TX_Sync.

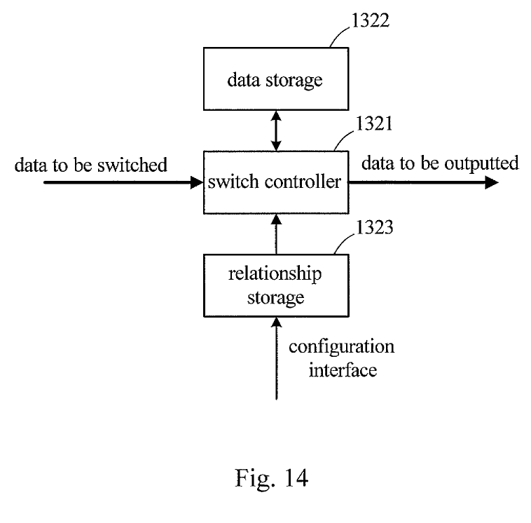

FIG. 14 is a schematic diagram illustrating a structure of a switch unit 1320 in FIG. 13. As shown in FIG. 14, the switch unit 1320 includes a switch controller 1321, a data storage 1322 and a relationship storage 1323.

The data storage 1322 is adapted to store the data to be switched.

The relationship storage 1323 is adapted to store the relationship between the serial numbers of the input time slots of Ethernet ports and the storage addresses of the data in the data storage 1322, and store the relationship between the serial numbers of the output time slots of the Ethernet ports and the storage addresses of the data in the data storage 1322. The above relationships are established by the configuration unit 1310 and are sent to the relationship storage 1323. The relationships stored in the relationship storage 1323 may be manually or dynamically configured. The relationship storage 1323 provides a configuration interface adapted to receive configuration information that is used for configuring the relationships. The configuration information may be from the configuration unit 1310, or be provided by a network manager or an upstream or downstream device.

In practical applications, the relationship between the serial numbers of the input time slots of the Ethernet ports and the storage addresses are preconfigured and remain unchanged; the relationship between the serial numbers of the output time slots of the Ethernet ports and the storage addresses may be manually or dynamically configured. In this way, the relationship storage 1323 may only store the relationship between the serial numbers of the output time slots and the storage addresses, while the relationship between the serial numbers of the input time slots and the storage addresses that are configured to be unchanged are directly stored in the switch controller 1321.

The switch controller 1321 is adapted to receive data at the input time slots of Ethernet port 1330, and stores the data to be switched which is received at the input time slots into the storage addresses in the data storage 1322 according to the relationship between the serial numbers of the input time slots and the storage addresses obtained from the relationship storage 1323; read the data from the storage addresses corresponding to the serial numbers of the output time slots of the data to be outputted, and send the data to an Ethernet port 1330 having the output time slots of the data to be outputted. The serial numbers of the output time slots of the data to be outputted may be provided by the Ethernet port 1330 to the switch controller 1321.

In practical applications, it may only switch the service flow in the Ethernet frame with the constant length, and the configuration unit 1310 does not number the input time slots and output time slot corresponding to at least one of the Preamble, the SFD, and the IFG in the Ethernet frame with the constant length. When the switch controller 1321 determines that the input time slot of the received data to be switched is not numbered, the switch controller 1321 waits for processing a next input time slot. Accordingly, after the switch is done, the Preamble, the SFD, and the IFG are constructed for the switched service flows, and when the switch controller 1321 determines that the output time slot of the data to be outputted is not numbered, the switch controller 1321 outputs the Preamble, the SFD, or the IFG corresponding to the output time slot.

The switch controller 1321 outputs the data to the Ethernet port 1330 via an MII interface or GMII interface. The switch controller 1321 is integrated with a MAC layer that is connected to a PHY layer in the Ethernet port 1330. The MAC layer sends the data to be outputted to the PHY layer in Ethernet port 1330 according to the time slots.

In practical applications, the apparatus for performing a synchronous time division switch 1300 shown in FIG. 13 may further include m E1 interfaces and/or TDM interfaces with integral multiple E1 rates 1350, and m≧1. As long as the frame synchronous periodicities are identical, each E1 interfaces and/or TDM interfaces with integral multiple E1 rates 1350 can perform a synchronous time division switch with the Ethernet ports 1330. Also, the E1 interfaces and/or TDM interfaces with integral multiple E1 rates 1350 can obtain the synchronous information from the synchronizing unit 1340 and use the synchronous information to align the local synchronous clock.

Specifically, when establishing the relationships, the configuration unit 1310 further establishes a relationship between the serial numbers of the input time slots of the E1 interfaces and/or TDM interfaces with integral multiple E1 rates 1350 and the storage addresses of the data in the data storage 1322; and establishes a relationship between the serial numbers of the output time slots of the E1 interfaces and/or TDM interfaces with integral multiple E1 rates 1350 and the storage addresses of the data in the data storage 1322. Therefore, the switch unit 1320 can switch the data which is received at the time slots from the E1 interfaces and/or TDM interfaces with integral multiple E1 rates 1350, to the corresponding output time slots of corresponding ports according to the established relationship, thereby achieving a synchronous time division switch between the Ethernet ports 1330 and the E1 interfaces and/or TDM interfaces with integral multiple E1 rates 1350.

Actually, the apparatus for performing a synchronous time division switch provided by the embodiments of the present invention is applied in the Ethernet, and thus also may be called as an Ethernet switch. When the Ethernet switch includes TDM interfaces, switches according to the time slots between the Ethernet ports, between the Ethernet ports and the TDM interfaces, and between TDM interfaces of the Ethernet switch, can be achieved.

As can be seen, by applying the method for performing a synchronous time division switch provided by the embodiments of the present invention, the synchronous time division switch via the Ethernet can be implemented. Because of the low cost of Ethernet lines, the synchronous time division switch according to the present invention has better quality-price ratio than the conventional synchronous time division switch implemented on the TDM interfaces and TDM lines.

The above description only describes embodiments of the present invention and is not intended to limit the present invention. Those skilled in the art should understand that any modification, equivalent, and improvement without apart from the scope of the present invention will be covered by the scope of the present invention.

1. A method for performing a synchronous time division switch, comprising:
dividing, by using a time period for transmitting one byte of data as a unit, a time period for receiving an Ethernet frame with a constant length by an Ethernet port into input time slots; and orderly numbering the input time slots;
dividing, by using the time period for transmitting one byte of data as a unit, a time period for sending the Ethernet frame with the constant length by the Ethernet port into output time slots; and orderly numbering the output time slots;
circularly receiving data via the Ethernet port according to serial numbers of the input time slots;
switching the data received at each input time slot to the output time slot corresponding to the input time slot; and
circularly outputting the data at the output time slots via the Ethernet port according to serial numbers of the output time slots.

2. The method of claim 1, wherein circularly receiving data via the Ethernet port according to the serial numbers of the input time slots comprises:
under a control of a local synchronous clock, using the time period for transmitting the Ethernet frame with the constant length as a frame synchronous periodicity, and at a start of the frame synchronous periodicity, circularly and orderly receiving the data of the Ethernet frame with the constant length according to the serial numbers of the input time slots via an Media Independent Interface (MII) or a Gigabit Media Independent Interface (GMII) between an switch unit and the Ethernet port.

3. The method of claim 2, wherein the frame synchronous periodicity is used as a receiving frame synchronous periodicity, and when a receiving enable signal RX_DV in the MII or GMII is enabled, the receiving frame synchronous periodicity is started; or when the receiving enable signal RX_DV in the MI or GMII is enabled and a Start Frame Delimiter (SFD) of the Ethernet frame with the constant length is received, the receiving frame synchronous periodicity is started.

4. The method of claim 1, wherein circularly outputting the data at the output time slots via the Ethernet port comprises:
under a control of a local synchronous clock, using a time period for transmitting the Ethernet frame with the constant length as a frame synchronous periodicity, and at a start of the frame synchronous periodicity, circularly and orderly transmitting the data of the Ethernet frame with the constant length according to the serial numbers of the output time slots via an MII or a GMII between an switch unit and the Ethernet port.

5. The method of claim 4, wherein the frame synchronous periodicity is used as a transmitting frame synchronous periodicity, and when a transmitting enable signal TX_EN in the MII or GMII is enabled, the transmitting frame synchronous periodicity is started;

6. The method of claim 1, further comprising:
establishing a relationship between the serial numbers of the input time slots and storage addresses; and establishing a relationship between the serial numbers of the output time slots and the storage addresses; wherein
switching the data received at each input time slot to the output time slot corresponding to the input time slot comprises: storing the data received at each input time slot in the storage address corresponding to the input time slot according to the relationship between the serial numbers of the input time slots and the storage addresses; and
circularly outputting the data at the output time slots via the Ethernet port according to serial numbers of the output time slots comprises: circularly outputting the data in the storage addresses corresponding to the output time slots according to the relationship between the serial numbers of the output time slots and the storage addresses.

7. The method of claim 1, wherein switching the data received at each input time slot to the output time slot corresponding to the input time slot comprises:
Switching the data of frame available contents in an Ethernet frame with the constant length received at the input time slot to the output time slot corresponding to the input time slot, and discarding a Preamble, a Start Frame Delimiter (SFD), and an Inter Frame Gap (IFG);
circularly outputting the data at the output time slots via the Ethernet port further comprises: configuring a Preamble at the time slot corresponding to the Preamble and outputting the Preamble; configuring an SFD at the time slot corresponding to the SFD and outputting the SFD; and configuring an IFG at the time slot corresponding to the IFG and outputting the IFG.

8. The method of claim 7, wherein orderly numbering the input time slots comprises:
orderly numbering the input time slots corresponding to the frame available contents in the Ethernet frame with the constant length; and
orderly numbering the output time slots comprises: orderly numbering the output time slots corresponding to the frame available contents in the Ethernet frame with the constant length;
wherein switching the data of the frame available contents in the Ethernet frame with the constant length received at the input time slot to the output time slot corresponding to the input time slot, and discarding the Preamble, the SFD, and the IFG comprises:
determining whether the input time slot has a serial number, if the input time slot has a serial number, storing the data received at the input time slot into the storage address corresponding to the serial number of the input time slot; otherwise, discarding the data received at the input time slot;
wherein circularly outputting the data at the output time slots comprises: determining whether the output time slot has a serial number, if the output time slot has a serial number, outputting the data in the storage address corresponding to the serial number of the output time slot; otherwise, outputting the Preamble, the SFD, or the IFG corresponding to the output time slot.

9. The method of claim 1, wherein the time period for transmitting the Ethernet frame with the constant length is used as a frame synchronous periodicity; and
circularly outputting the data at the output time slots via the Ethernet port further comprises:
circularly outputting the data at the output time slots of at least one of an E1 interface and a TDM interface having an integral multiple E1 rate, the E1 interface and the TDM interface having the integral multiple E1 rate having a same frame synchronous periodicity with the Ethernet port.

10. The method of claim 1, further comprising:
obtaining synchronous information by calculating sending time and arriving time of the Ethernet frame with the constant length, or by extracting an upstream line clock via a physical layer chip, or by using a synchronous system of a Global Positioning System (GPS), or by using a synchronous network of a Plesiochronous Digital Hierarchy (PDH) or a Synchronous Digital Hierarchy (SDH);
aligning local synchronous clocks of the Ethernet port according to the synchronous information.

11. A method for performing a synchronous time division switch, comprising:
dividing, by using a time period for transmitting one byte of data as a unit, a time period for receiving an Ethernet frame with a constant length by an Ethernet port into input time slots and output time slots; and orderly numbering the input time slots;
dividing, by using the time period for transmitting one byte of data as a unit, a time period for sending the Ethernet frame with the constant length by the Ethernet port into output time slots;
using the time period for transmitting the Ethernet frame with the constant length as a frame synchronous periodicity;
circularly receiving data via the Ethernet port according to serial numbers of the input time slots of the Ethernet port, and circularly receiving data via at least one of an E1 interface and a TDM interface having an integral multiple E1 rate according to serial numbers of the input time slots of the at least one of the E1 interface and the TDM interface having the integral multiple E1 rate;
switching the data received at each input time slot to the output time slot corresponding to the input time slot; and
circularly outputting the data at the output time slots via the Ethernet port according to serial numbers of the output time slots of the Ethernet port, and circularly outputting the data at the output time slots via the at least one of the E1 interface and the TDM interface having the integral multiple E1 rate according to serial numbers of the output time slots of the at least one of the E1 interface and the TDM interface having the integral multiple E1 rate.

12. An apparatus for performing a synchronous time division switch, comprising a configuration unit, a switch unit and at least two Ethernet ports; wherein
the configuration unit is adapted to divide, by using a time period for transmitting one byte of data as a unit, a time period for receiving an Ethernet frame with a constant length by an Ethernet port into input time slots; and orderly numbering the input time slots; divide, by using the time period for transmitting one byte of data as a unit, a time period for sending the Ethernet frame with the constant length by the Ethernet port into output time slots; and orderly number the output time slots; determine a relationship between the input time slots and the output time slots, and send the relationship to the switch unit;
the switch unit is adapted to switch data received at each input time slot to the output time slot corresponding to the input time slot according to the relationship; and
the Ethernet port is adapted to circularly receive the data according to serial numbers of the input time slots, and output the data at the output time slots via the Ethernet port according to serial numbers of the output time slots.

13. The apparatus of claim 12, further comprising:
an Media Independent Interface (MI) or a Gigabit Media Independent Interface (GMII) between the Ethernet port and the switch unit, adapted to, under a control of a local synchronous clock, use the time period for transmitting the Ethernet frame with the constant length as a receiving frame synchronous periodicity and a sending frame synchronous periodicity, and at a start of the receiving frame synchronous periodicity, orderly sending, according to the serial numbers of the input time slots, the data received by the Ethernet port to the switch unit, and at a start of the sending frame synchronous periodicity, orderly sending, according to the serial numbers of the output time slots, the data switched by the switch unit to the Ethernet port.

14. The apparatus of claim 13, wherein the MII or the GMII interface is further adapted to start the receiving frame synchronous periodicity when a receiving enable signal RX_DV is enabled, or when the receiving enable signal RX_DV is enabled and a Start Frame Delimiter (SFD) of the Ethernet frame with the constant length is received; start the sending frame synchronous periodicity when a sending enable signal TX_EN is enabled.

15. The apparatus of claim 12, wherein the switch unit comprises a switch controller, a data storage, and a relationship storage; wherein
the configuration unit is further adapted to establish a relationship between the serial numbers of the input time slots and storage addresses of data in the data storage, establish a relationship between the serial numbers of the output time slots and storage addresses of the data in the data storage, and send the relationships to the switch unit;
the data storage is adapted to store the data to be switched;
the relationship storage is adapted to store the relationship between the serial numbers of the output time slots and the storage addresses received from the configuration unit; and
the switch controller is adapted to, according to the relationship between the serial numbers of the input time slots and the storage addresses, and according to the storage addresses corresponding to the serial numbers of the input time slots of the received data to be switched, store the data to be switched in the corresponding storage addresses; and according to the relationship between the serial numbers of the output time slots and storage addresses obtained from the relationship storage, obtain the storage addresses corresponding to the serial numbers of the output time slots of the data to be outputted, read the data from the corresponding storage addresses and output the data.

16. The apparatus of claim 12, wherein the switch unit is adapted to switch the data to be switched which correspond to frame available contents in the Ethernet frame with the constant length and are received at each input time slot, to the corresponding output time slot, discard a Preamble, a Start Frame Delimiter (SFD), and an Inter Frame Gap (IFG) received at the input time slot, and when output the data in the Ethernet frame with the constant length, configure the Preamble at the time slot corresponding to the Preamble, configure the SFD at the time slot corresponding to the SFD, and configure the IFG at the time slot corresponding to the IFG.

17. The apparatus of claim 12, further comprising:
at least one of an E1 interface and a TDM interface having an integral multiple E1 rate, the E1 interface and the TDM interface having the integral multiple E1 rate having a same frame synchronous periodicity with the Ethernet port; the frame synchronous periodicity being equal to the time period for transmitting the Ethernet frame with the constant length.

18. The apparatus of claim 12, wherein the Ethernet port and the switch unit are further adapted to work under the control of respective local synchronous clocks; and
the apparatus further comprises a synchronizing unit, adapted to provide synchronous information used to align the local synchronous clocks of the Ethernet port and the switch unit.

19. An Ethernet switch, comprising:
at least one Ethernet interface unit, adapted to transmit an Ethernet frame with a constant length, and transmit the Ethernet frame with the constant length at multiple time slots, one byte being transmitted at one time slot;
at least one TDM interface unit, adapted to comprise multiple time slots, wherein a time period for transmitting the Ethernet frame with the constant length is a integral multiple of a frame synchronous periodicity of the TDM interface unit; and
a switch unit, adapted to perform a switch at the time slots between the at least one Ethernet interface unit and the at least one TDM interface unit.

20. The Ethernet switch of claim 19, wherein the at least one Ethernet interface unit is further adapted to discard a Preamble, a Start Frame Delimiter (SFD), and an Inter Frame Gap (IFG) before the Ethernet frame is transmitted at the time slots.
